(19) United States
(12) Patent Application Publication
(10) Pub. No.: US 2008/0017055 A1
(43) Pub. Date: Jan. 24, 2008

(54) METHOD AND APPARATUS FOR EXCHANGING SUBSTRATE PROCESSING TECHNOLOGIES

(76) Inventors: John B. HOWARD, Wildwood, MO (US); Kevin S. MANES, St. Charles, MO (US)

Correspondence Address: FOLEY AND LARDNER LLP;SUITE 500, 3000 K STREET NW, WASHINGTON, DC, 20007, US

(21) Appl. No.: 11/766,505

(22) Filed: Jun. 21, 2007

Related U.S. Application Data
(60) Provisional application No. 60/831,927, filed on Jul. 20, 2006.

(51) Int. Cl. B41F 9/00; B41M 1/10

(52) U.S. Cl. 101/153; 101/170

(57) ABSTRACT

A substrate processing press including a first dock assembly configured to readily receive, readily retain and readily release a first exchangeable substrate processing element while the first dock assembly is attached to the press. The press includes a second dock assembly adjacent to the first dock assembly configured to readily receive, readily retain and readily release a second exchangeable substrate processing element while the first exchangeable substrate processing element is retained in the first dock assembly and attached to the press and while the second dock assembly is attached to the press. The press is configured such that the first exchangeable substrate processing element and the second exchangeable substrate processing element are removable from the press while the other exchangeable substrate processing element remains in the press.

### CROSS-REFERENCE TO RELATED PATENT APPLICATIONS

This application claims priority to U.S. Provisional Patent Application No. 60/831,927, filed Jul. 20, 2006, the contents of which is incorporated herein by reference in its entirety.

### BACKGROUND OF THE INVENTION

Portable process heads are currently essential in substrate (e.g., sheet and substrate) printing and converting technologies (collectively and nonexhaustively referred to as processing technologies) to allow the operator the versatility to reconfigure substrate processing systems to perform the wide variety of jobs now required in the substrate printing and converting industry. For example, a press may have a first process head for flexographic printing, and a second process head for gravure printing.

A variety of presses are on the market that have removable/replaceable process heads, the heads being used to execute substrate processing. These removable process heads are designed to be removed or installed at various locations within a process zone in the press. For example, a press may be configured such that the first process head may be removed and the second may be installed in its place, so as to reconfigure the press from a flexographic printing press to a gravure printing press.

The presses that offer such removable process heads typically require the operator to disconnect a variety of components in order to remove the head and then to reconnect a new process head and reconnect the components. Furthermore, these presses require the operator to utilize lifting equipment, such as overhead cranes or lifting dollies, to remove and install the head. The process of exchanging/converting the press/station to implement the different processing technology is time consuming and not operator friendly. Even worse, it creates a risk that a head or the base printer or converter itself can be significantly damaged or even destroyed by, for example, the kinetic energy imparted into either component by a swinging processing head which may weigh between 300 and 500 pounds. There is the inherent risk that exchanging the print head presents an opportunity for the press operator/technician to injure himself or herself while removing and installing the head.

### SUMMARY OF THE INVENTION

In a first embodiment of the present invention, there is a substrate processing press, comprising a first substrate processing station including a first dock assembly configured to readily receive, readily retain and readily release a first exchangeable substrate processing element while the first dock assembly is attached to the press, and a second dock assembly adjacent to the first dock assembly configured to readily receive, readily retain and readily release a second exchangeable substrate processing element while the first exchangeable substrate processing element is retained in the first dock assembly and attached to the press and while the second dock assembly is attached to the press, wherein the press is configured such that the first exchangeable substrate processing element and the second exchangeable substrate processing element are removable from the press while the other exchangeable substrate processing element remains in the press, wherein the press is configured such that the first exchangeable substrate processing element, when docked in the first dock assembly, and the second exchangeable substrate processing element, when docked in the second dock assembly, simultaneously contact opposite sides of a substrate passing through the first substrate processing station at substantially the same longitudinal location of the substrate, and wherein the second dock assembly is configured to readily receive, readily retain and readily release at separate temporal locations (i) the second exchangeable substrate processing element and (ii) a third exchangeable substrate processing element that is of a different processing technology than that of the second exchangeable substrate processing element while the second dock assembly is attached to the press and while the first exchangeable substrate processing element is attached to the press.

In another embodiment of the present invention, there is a press as described above and/or below, wherein at least a portion of one of the first and second dock assemblies is movable so as to permit an operator to adjust a contact pressure (i) between the first and second processing elements and/or (ii) on the substrate due to movement of the portion. In another embodiment of the present invention, there is a press as described above and/or below, wherein the first exchangeable substrate processing element is an impression element, and wherein the press is configured to selectively drive and idle the impression element when received in the first dock assembly. In another embodiment of the present invention, there is a press as described above and/or below, wherein the second exchangeable substrate processing element is an element selected from the group comprising at least a flexographic element and a gravure element, wherein the second dock assembly is configured to receive, at different temporal positions, the flexographic element and the gravure element while the second dock assembly is attached to the press so as to reconfigure the first station from a flexographic printing station to a gravure printing station, and wherein the press is configured to drive the second exchangeable substrate processing element. In another embodiment of the present invention, there is a press as described above and/or below, wherein the second exchangeable substrate processing element is an element selected from the group comprising at least a flexographic plate, a lithographic offset blanket, a gravure imaged sleeve, a substrate cutter, a rotary screen and a gravure offset blanket, and wherein the second dock assembly is configured to receive, at different temporal locations, the flexographic plate, the lithographic offset blanket, the gravure imaged sleeve, the substrate cutter and the gravure offset blanket while the second dock assembly is attached to the press, and wherein the press is configured to drive the second exchangeable substrate processing element.

In another embodiment of the present invention, there is a press as described above and/or below, further comprising a third dock assembly adjacent to the second dock assembly configured to readily receive, readily retain and readily release a fourth exchangeable substrate processing element while the first exchangeable substrate processing element is operationally retained in the first dock assembly and in the press, while the second exchangeable substrate processing element is operationally retained in the second dock assembly and in the press and while the third dock assembly is attached to the press, wherein the press is configured such that the fourth exchangeable substrate processing element is removable from the press while the first and second exchangeable substrate processing elements remain connected to the press, and wherein the press is configured such that the second exchangeable substrate processing element, when docked in the second dock assembly, and the fourth exchangeable substrate processing element, when docked in the third dock assembly, contact each other.

In another embodiment of the present invention, there is a substrate processing press, comprising a first substrate processing station including a first driven mandrel attached to the press configured to readily receive, readily retain, readily release and readily drive a first exchangeable substrate processing element, a second driven mandrel attached to the press adjacent to the first mandrel configured to readily receive, readily retain, readily release and readily drive a second exchangeable substrate processing element while the first exchangeable substrate processing element is retained in the first dock assembly and attached to the press, and an impression cylinder attached to the press adjacent to the first mandrel configured to readily receive, readily retain, readily release and readily drive an impression element, wherein the press is configured such that the first exchangeable substrate processing element, the second exchangeable substrate processing element and the impression element are removable from the press while the other elements remain in the press, wherein the press is configured such that the first exchangeable substrate processing element, when received on the first mandrel, and the impression element, when received on the impression cylinder, simultaneously contact opposite sides of a substrate passing through the first substrate processing station at substantially the same longitudinal location of the substrate, and wherein the press is configured such that the first exchangeable substrate processing element, when retained on the first mandrel, and the second exchangeable substrate processing element, when retained on the second mandrel, contact each other.

In another embodiment of the present invention, there is a substrate processing press, comprising a first substrate processing station including a first exchangeable substrate processing element attached to the press, a second exchangeable substrate processing element attached to the press, wherein the press is configured to readily receive, readily retain and readily release the first exchangeable substrate processing element when a substrate is extended between the first and the second exchangeable elements while the second exchangeable substrate processing element is attached to the press, wherein the press is configured to readily receive, readily operationally retain and readily release the second exchangeable substrate processing element when the substrate is extended between the first and the second dock exchangeable elements while the first exchangeable substrate processing element is attached to the press, wherein the press is configured such that the first exchangeable substrate processing element and the second exchangeable substrate processing element simultaneously contact opposite sides of a substrate passing through the first substrate processing station at substantially the same longitudinal location of the substrate, and wherein the press is configured such that the first exchangeable substrate processing element and the second exchangeable substrate processing element is removable from the press while the substrate is extended between the first and the second exchangeable substrate processing elements.

In another embodiment of the present invention, there is a substrate processing press, comprising a first substrate processing station including a first mandrel attached to the press configured to readily receive, readily retain, and readily release an exchangeable gravure offset blanket, a second mandrel attached to the press adjacent to the first mandrel configured to readily receive, readily retain, and readily release an exchangeable gravure sleeve; and an impression cylinder attached to the press adjacent to the first mandrel, the impression cylinder configured to readily receive, readily retain and readily release an impression element, wherein the press is configured such that the exchangeable gravure offset blanket may be exchanged with a first separate exchangeable substrate processing element while the substrate is extended between the impression cylinder and the first mandrel, wherein the press is configured such that the gravure sleeve may be exchanged with a second separate exchangeable substrate processing element while the substrate is extended between the impression cylinder station and the first mandrel, wherein the press is configured such that the gravure offset blanket, when received on the first mandrel, and the impression element, when received on the impression cylinder, simultaneously contact opposite sides of the substrate passing through the press at substantially the same longitudinal location of the substrate, and wherein the press is configured such that the gravure sleeve, when retained on the second mandrel, and the gravure offset blanket, when retained on the first mandrel, contact each other.

In another embodiment of the present invention, there is a gravure printing press, comprising a first mandrel and a second mandrel attached to the press configured to readily receive, readily retain, and readily release an exchangeable gravure element, a chambered doctor blade, and a first exchangeable flexible gravure belt extending around the first and second mandrel in the form of an oblong endless belt.

In another embodiment, there is a press as described above and/or below, wherein the distance from a center of the first mandrel and a center of the second mandrel is adjustable in order to maintain an effectively similar operational tension, with respect the first exchangeable flexible gravure belt, on a second exchangeable flexible gravure belt of substantially longer repeat length than the first exchangeable flexible gravure belt when the first exchangeable flexible belt is replaced by the second exchangeable gravure belt and gravure printing is executed with the press.

In another embodiment, there is a press as described above and/or below, wherein the press is configured to permit a repeat length to be substantially changed and gravure printing to be executed without the need to (i) replace the chambered doctor blade, (ii) adjust an angle of blades in the chambered doctor blade, and (iii) adjust a seal of the chambered doctor blade from a contact radius of the first exchangeable flexible gravure belt.

In another embodiment, there is a gravure printing press, comprising a chambered doctor blade, and a first exchangeable flexible oblong gravure belt in the form of an oblong endless belt, wherein the gravure printing press is configured such that a repeat length may be substantially changed and gravure printing may be executed without the need to (i) replace the chambered doctor blade, (ii) adjust an angle of blades in the chambered doctor blade, and (iii) adjust a seal of the chambered doctor blade to a contact radius of the first exchangeable flexible gravure belt.

### BRIEF DESCRIPTION OF THE DRAWINGS

FIGS. 1a, 1b and 1c present, respectively, a side view and an angled view of a substrate processing press according to an exemplary embodiment of the present invention, where FIG. 1b presents processing elements that have been moved away from the line of the press.

FIG. 2 presents an isometric view of a processing station in the press of FIG. 1, where support(s) for the mandrels/cylinders 310 have been removed for clarity.

FIG. 3 presents a side view of the processing station of FIG. 2.

FIG. 4 presents an isometric view of the processing station of FIG. 2 with processing elements received in the press.

FIG. 5 presents a side view of a portion of the view depicted in FIG. 4, depicting flexographic processing elements.

FIG. 6 presents a side view of a portion of the station depicted in FIG. 2, except that offset gravure processing elements have been installed in the station.

FIG. 7 presents a side view of a portion of the station depicted in FIG. 2, except that direct gravure processing elements have been installed in the station.

FIG. 8 presents a side view of a portion of the station depicted in FIG. 2, except that lithographic processing elements have been installed in the station.

FIGS. 9 and 10 present side views of the station of FIG. 2, except that a flexible gravure sleeve in the form of an oblong elongated endless belt has been installed at two dock assemblies of the station.

FIG. 11 presents a side view of a phenomenon that occurs in prior art substrate processing presses.

FIG. 12 presents an exemplary embodiment of orifice placement.

FIG. 13 presents an exemplary embodiment depicting processing reconfiguration in progress.

FIG. 14 presents an exemplary embodiment of the present invention set up for flexographic processing.

FIG. 15 presents an exemplary embodiment of the present invention set up for gravure processing.

FIGS. 16a and 16b present exemplary embodiments showing a support system for the mandrels, where the mandrels are supported on a rail system.

### DETAILED DESCRIPTION OF EMBODIMENTS

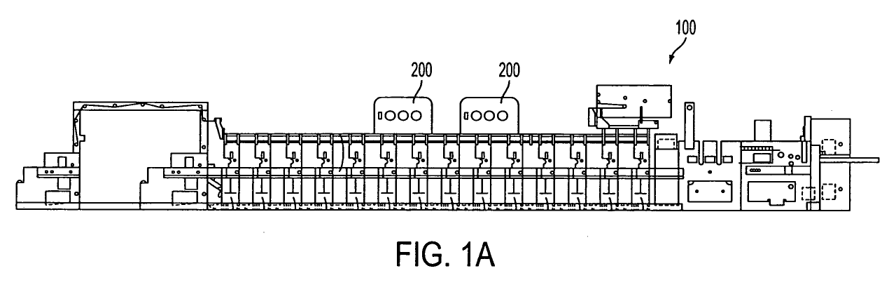

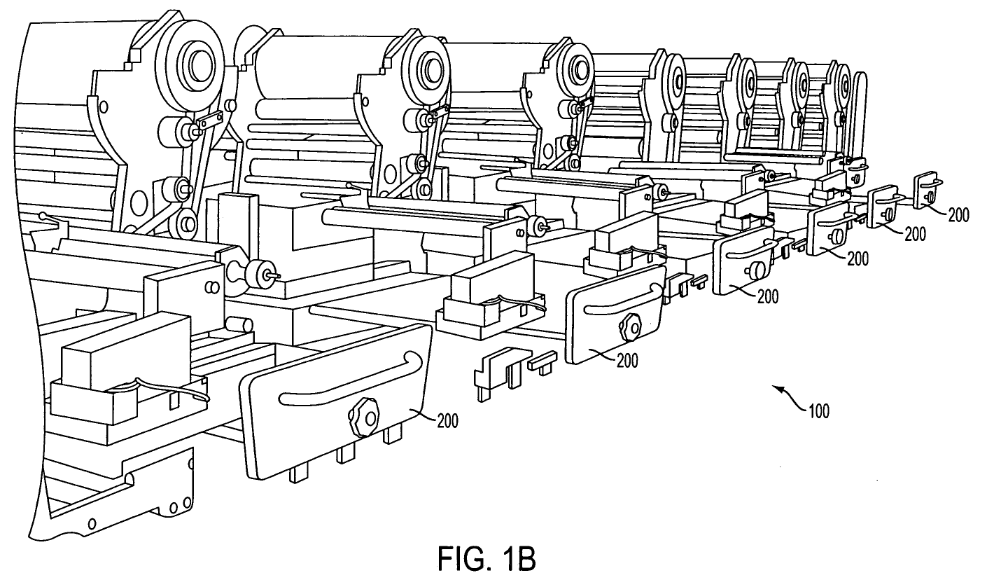

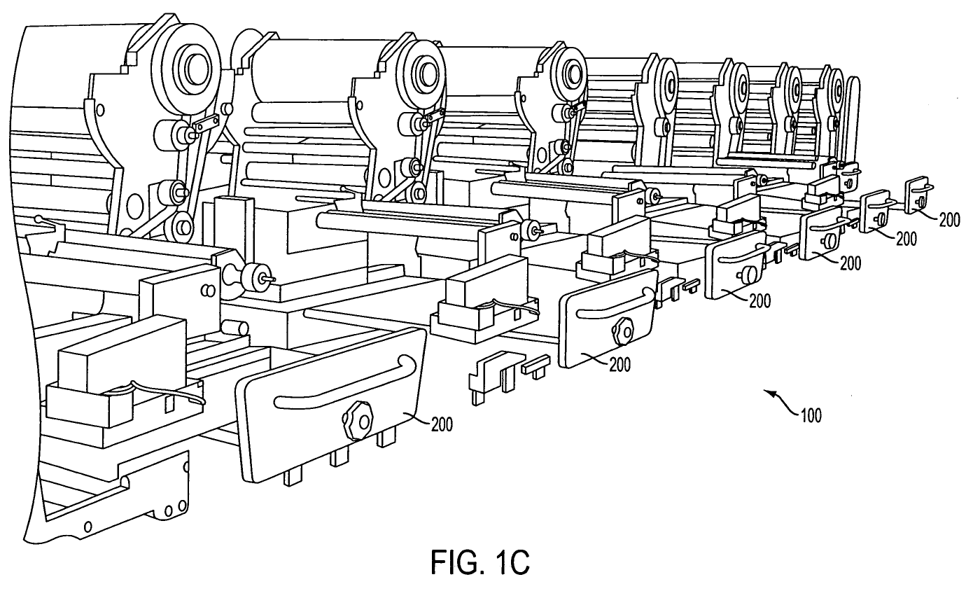

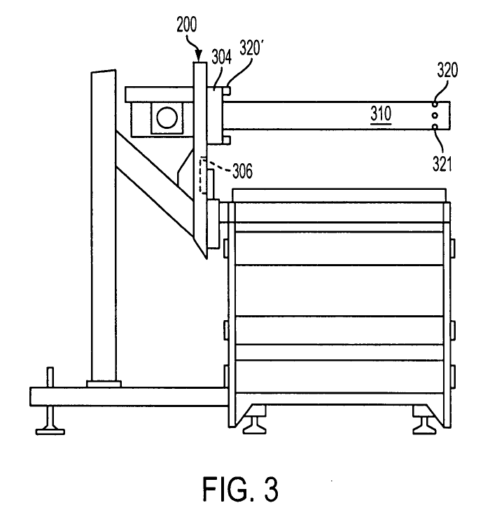

In a first exemplary embodiment of the present invention, with reference to FIGS. 1a-4, there is a substrate processing press 100 that includes one or more reconfigurable substrate processing stations 200 for processing a substrate 1000. The substrate processing stations 200 include one or more individual dock (also referred to as docking) assemblies (identified in the figures as dock assemblies 300, 302, 304, 306 and 308, although fewer or additional dock assemblies may be present in other embodiments) that are configured to readily receive, readily retain and readily release exchangeable substrate processing elements while the dock assemblies are attached to the press. That is, in this first exemplary embodiment, the press 100 may be reconfigured to utilize different types of print technologies by swapping out individual substrate processing elements, as opposed to removing entire processing heads from the press.

In some embodiments, the dock assemblies include mandrels/cylinders 310 which are configured to support various exchangeable substrate processing elements, particularly elements that rotate during substrate processing. In a first exemplary embodiment, the exchangeable substrate processing elements include impression elements, flexographic printing elements, and gravure printing elements. The mandrels may also be configured to support substrate cutters and other substrate processing components, etc. (to be described below). In some embodiments, the elements may also include die cutting elements, embossing elements, etc. In other embodiments, the dock assemblies are cavities that receive the exchangeable substrate processing elements, which may include inkers and/or some or all of the just-mentioned elements. In yet other embodiments, the dock assemblies are in the form of lugs. Any component that will readily receive, readily retain and readily release (at the direction of the press operator/technician) a processing element may be utilized as a dock assembly. These various substrate processing elements may be “swapped out” at the dock assemblies with the other processing elements to convert the substrate processing press to utilize different processing technologies, once the elements have been released from the dock assemblies, as will now be described.

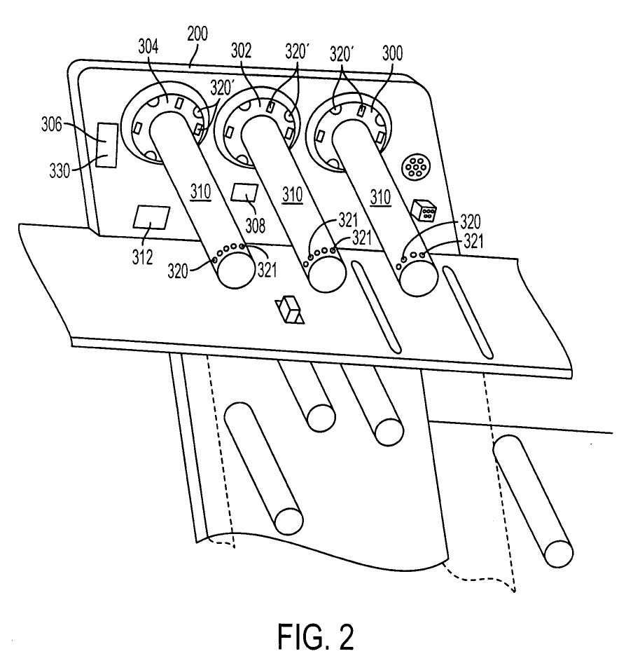

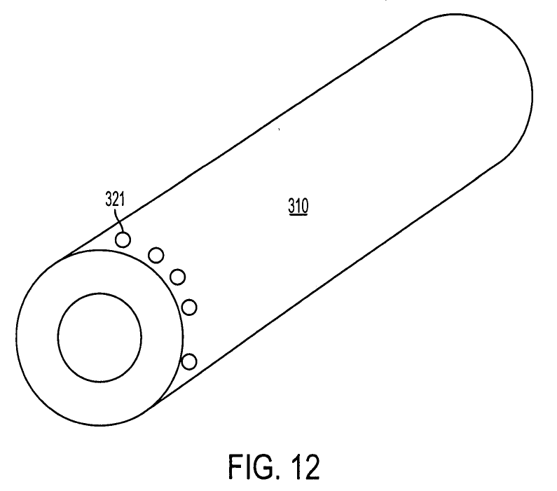

The various elements may be “locked” into place on the press/in the docking assemblies (and thus readily retained in the press). In some embodiments, at least where the processing element is a sleeve that fits over a mandrel, the processing element has an interior diameter that would interfere or otherwise fit relatively tightly around the mandrel without external influence. However, in an exemplary embodiment, the processing element is expandable such that the interior diameter may be enlarged/expanded when, for example, a pressure force is applied to the interior the processing element. Accordingly, in some embodiments, referring to FIG. 2, the press is configured with locking components 320 which direct air, under pressure, out orifices 321 on the mandrel to expand the interior diameter of the processing element such that it may be more easily fitted over the mandrel. In some embodiments of the present invention, air ports/orifices 321 are right at the end of the mandrels, as may be seen in FIG. 12. As soon as the sleeve goes over them, the air is pressurized and expands the sleeve across the overlap of the sleeve and the mandrel. To secure the processing element to the mandrel, the supply of air is cut off, and thus the interior diameter of the processing element shrinks/contracts, thereby securing the processing element snugly on the mandrel. That is, when a sleeve is fully on the mandrel and the air supply is turned off, the sleeve contracts back and “squeezes” the mandrel, like a rubber band on the mandrel. To remove the processing element, air is again directed, under pressure, out the orifices on the mandrel, thereby expanding the element such that an operator may easily slide the processing element off the mandrel. In some embodiments, the forced air effectively tensions the processing element, and once that tension is relieved, the element is secured to the mandrel.

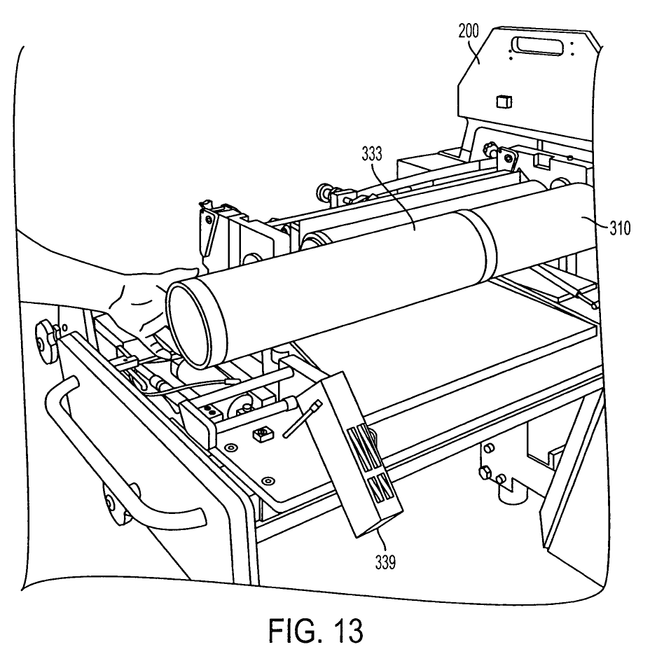

FIG. 13 depicts an exemplary embodiment of the present invention where an operator is in the process of moving an exemplary processing element 333 from an exemplary mandrel/cylinder 310. In FIG. 13, a mandrel support 339 has been rotated out of the path of the processing element 333.

In some embodiments, the interior edge of the processing elements is tapered so that it fits more easily over the mandrel. In other embodiments, the outer diameter of the mandrel is tapered. In yet other embodiments, both the processing elements and the mandrel are tapered.

In other embodiments, “quick release” components are utilized, such as locking components 320′, which may include ball-detent components and positive retention components, etc. For example, in the case of an exchangeable substrate processing element bearing an impression sleeve with an axial space for receiving a cylinder/mandrel 310 thereon, a press operator may simply slide the circular impression element over the impression cylinder/mandrel 310 at docking station 300, whereby upon the impression sleeve having traveled a sufficient distance along the cylinder 310, spring loaded balls spring into detents inside the circular impression element, at which point a longitudinal force of no less than, by way of example only and not by way of limitation, 20 pounds, must be applied to the circular impression element to release the circular impression element from the press. Other configurations may utilize hand retractable plungers to retain/release the cylinders (Exemplary concepts of ball plungers and spring plungers and hand retractable plungers may be found in the catalogues of the Carr Lane Manufacturing Co. of St. Louis, Mo., U.S.A.).

It may be seen that the processing elements are located on the press in close relationship to one another. In some embodiments, the press is configured such that the processing elements may be moved upward and/or downward to provide extra clearance between the processing elements.

Some specifics of some of the various embodiments will now be described by way of describing some exemplary press reconfiguration scenarios.

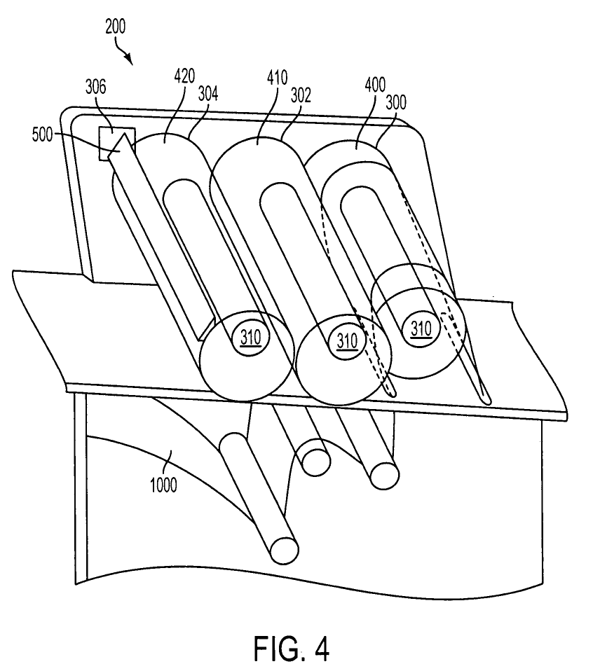

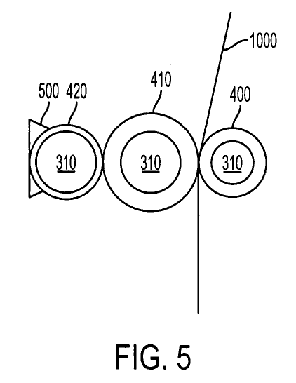

In reference to FIGS. 4 and 5, a substrate processing press station 200 is initially arranged for flexographic printing. In some embodiments, the substrate is a paper substrate (e.g., a paper web), while in others, it is a plastic substrate, and may be made of other types of material. As seen in FIG. 4, exchangeable substrate processing elements 400, 410 and 420 are initially retained on the respective mandrels/cylinders 310 in dock assemblies 300, 302 and 304, and exchangeable substrate processing element 500 is retained in dock assembly 306. FIG. 5 shows an exemplary station 200 from a side view of the view depicted in FIG. 4. The views depicted in FIG. 4 and FIG. 5 present a substrate processing station set up for flexographic printing. In FIGS. 4 and 5, element 400 is an impression sleeve/surface. Element 410 is a flexographic (or flexo) plate sleeve. Element 420 is an anilox sleeve. Further, element 500 is a doctor blade (which may be, in some embodiments, a variable geometry chambered doctor blade). In this embodiment, the impression element is a hard element. Accordingly, the station 200 depicted in FIGS. 4 and 5, and thus the press 100, is configured for flexographic printing.

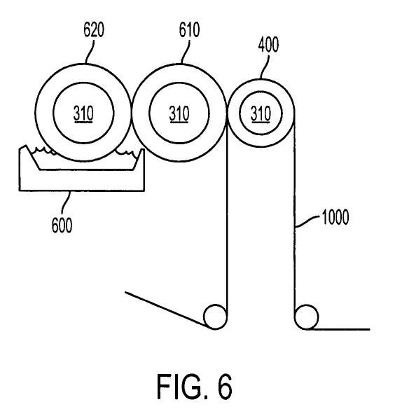

If a press operator seeks to reconfigure the station/press, for example, to offset gravure printing, from a configuration for flexographic printing, the operator/technician may convert the station from a flexographic printing station to an offset gravure printing station. In this scenario, the operator or press technician, etc., removes the exchangeable substrate processing element 400 used during flexographic printing, which in this case is a hard impression sleeve, and replaces it with an impression element that has a surface of about 90 durometers or so for gravure printing. The removal of the hard impression sleeve 400 of FIG. 5 may be accomplished while the flexographic plate sleeve 410 and/or the anilox sleeve 420 of FIG. 5 are still on their respective mandrels 310/ still retained in the substrate processing press. In yet another exemplary scenario of reconfiguring the press 100/the station 200, the exchangeable element 410 of FIG. 5, which in this scenario is a flexographic plate sleeve, may be removed from mandrel 310/docking station 302 while the hard impression surface 400 and the anilox sleeve 420 of FIG. 5 are retained in the press 100. Still further, the anilox sleeve 420 of FIG. 5 may be removed from the substrate processing station 200/the press 100 while the flexoplate sleeve 420 and the hard impression surface 400 of FIG. 5 remain secured in the press. Accordingly, when converting from flexographic printing to offset gravure printing, the anilox sleeve may be replaced with a gravure imaged sleeve 620 (see FIG. 6, which is a side view of a portion of a substrate processing station after it has been reconfigured for offset gravure printing), and the flexoplate sleeve may be replaced with a gravure offset blanket 610 (see FIG. 6). Still further, the chambered doctor blade 500 depicted in FIG. 5 may be replaced with an open pan inker 600, as may be seen in FIG. 6. It will be noted that in other embodiments, the inker 600 may be a variable geometry chambered doctor blade (where the variable geometry accommodates changing diameters of the gravure sleeve). In this regard, instead of the open pan inker 600 depicted in FIG. 6, the chambered doctor blade 500 of FIG. 5 or the equivalent may be utilized. It is noted that the press/station may include an additional docking assembly 312 (shown in FIG. 2) to support the open pan inker 600, as its relative location with respect to the docking assembly for the gravure sleeve 420 of FIG. 6 may be different with respect to the location of the chambered doctor blade 500 of FIG. 5, and thus the docking station 306 may not be utilized for offset gravure printing.

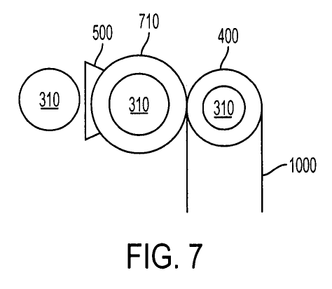

In another exemplary scenario of reconfiguring the substrate processing press according to an embodiment of the present invention, the press 100, or at least a substrate processing station 200, is reconfigured from an offset gravure printing configuration, as depicted in FIG. 6, to a direct gravure printing station as depicted in FIG. 7. In this regard, while the impression surface 400 may be the same as that utilized in the offset gravure printing scenario just described, the gravure blanket 410 depicted in FIG. 6 is replaced with a gravure sleeve 710, depicted in FIG. 7, and this step may be accomplished while the other elements are attached to the press. Further, a chambered doctor blade 500 (which may be variable) is utilized, which may be the same as that utilized in the flexographic printing scenario. The step of removing the open pan 600 of FIG. 6 and/or the step of replacing it with the chambered doctor blade 500 of FIGS. 7 or 5 may be accomplished while the other elements for offset gravure printing (or flexographic printing, if converting from that technology), are attached to the press (although in some embodiments, the elements may be moved to provide additional clearance). It is noted that while the reconfigured station 200 is presented in this embodiment as having three dock assemblies which have respective mandrels/cylinders 310, according to the present scenario, only two dock assemblies with respective two mandrels are utilized (the mandrel for the impression surface and the mandrel for the gravure sleeve), where the substrate 1000 runs in between those two components, as seen in FIG. 7. In some embodiments, the third mandrel that is not utilized may be configured to be moved out of the way to provide clearance for the chambered doctor blade 500, which is mounted on another dock assembly separate from the dock assembly that includes that unused mandrel (e.g., dock assembly 308). However, in other embodiments of the present invention, the press 100 may be configured such that the variable chambered doctor blade 500 may be mounted on that mandrel 310 of dock assembly 304.

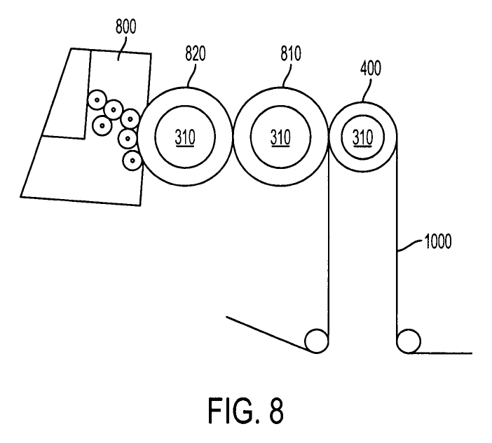

In another exemplary scenario, the press 100 is reconfigured for a lithographic offset printer/at least one of the substrate processing stations 200 is so configured. In this regard, when converting from flexographic printing, the flexographic plate sleeve may be removed while the other flexographic printing elements remain on the press. Alternatively, the anilox sleeve may be removed while the other flexographic printing elements remain on the press. When converting from gravure (direct) printing and gravure offset printing, etc., the gravure offset blanket and/or the gravure sleeve, as applicable, may be removed while the other gravure elements remain on the press. In their place, referring to FIG. 8, a lithographic offset blanket is placed in the second dock assembly 302, and a lithographic offset plate 420 is placed in the third dock assembly 304. Further, lithographic offset inking rollers 800 are provided as an inker for lithographic offset printing. When changing from flexographic printing to lithographic offset printing, in one embodiment, it may not be necessary to change the impression surface. That is, the same impression surface may be utilized; an impression surface with a sufficiently hard element for lithographic printing.

It may be seen that one advantage of some embodiments of the present invention is that the press may be reconfigured to utilize different printing technologies without interfering with the substrate path 1000, especially in the case of a substrate that runs in the vertical direction, as is depicted in some of the figures. That is, in some embodiments, one or more of the processing elements may be removed while the others remain in the press and while the substrate 1000 has substantially the same path that it had prior to the commencement of press reconfiguration. Still, of course, another advantage, is that the press/station may be reconfigured without the need for overhead equipment and/or the need to move bulky, heavy components, such as print heads. In this regard, the ability to “swap out” various exchangeable individual print elements without the need to remove an entire printing head provides advantages over current processing presses.

While the above scenarios detail removing components for one processing technology and substituting components for another processing technology (e.g., flexographic components being removed and gravure offset components being positioned in their place, etc.), it will be understood that the above scenarios may be modified in regard to removing components from other processing technologies and substituting components from yet other technologies (e.g, lithographic components being removed and flexographic components being position in their place, flexographic components being replaced by lithographic components, flexographic components being replaced by substrate cutting components, to name a few).

It will be noted that other processing technologies may be utilized with the substrate processing press, according to the present invention. By way of example only, and not by way of limitation, the exchangeable substrate processing elements may comprise substrate cutters incorporated into one or more of the stations, screen printing components, hot foil components, cold foil components, inkjet, substrate embossing, substrate heating, etc., incorporated into one or more of the stations, again without the need to remove an entire print head assembly or the like, instead reconfiguring the press/station in a manner concomitant to the scenarios just described.

Some specific features of some embodiments of the present invention will now be discussed. Some substrate processing stations 200 utilized in the substrate processing press 100 of the present invention include a plurality of dock assemblies. The dock assemblies, such as dock assemblies 300, 302, 304, 306, 308 and 312, as exemplarily depicted in FIG. 2, are configured to readily receive, readily retain and readily release exchangeable substrate processing elements while those docking assemblies are attached to the press/on the press 100. By readily received and readily released, it is meant that the exchangeable substrate processing elements may be swapped out with relative ease and relative minimal equipment/time. By readily retained, it is meant that the components will be retained in the press in a manner that would permit those components to be utilized assuming that other components are also present and located properly for substrate processing. In this regard, in some embodiments, a press operator of average skill may be typically able to, after some experience, approach a fully operational processing station configured for gravure printing and remove a gravure blanket from, for example, the dock assembly 302 in about 2-3 minutes, and install a flexoplate sleeve in that same dock assembly 302 in about 2-3 minutes, after the other pertinent elements are removed, if necessary. In some embodiments, the entire process of converting a station from one print technology to another (e.g., flexographic to offset gravure printing) may be accomplished in about 10 minutes, which includes removing the elements one element at a time and replacing the elements one element at a time. In some embodiments, the reconfiguration may be performed while substrate processing is taking place (if that station is not utilized). This swap out may be accomplished by the press operator without the need for overhead cranes, lifts, or hefty support equipment, etc. Again, the dock assemblies according to embodiments of the present invention are configured to readily receive, readily retain, and readily release the various exchangeable substrate processing elements while other exchangeable substrate processing elements are in the other dock assemblies and attached to the press.

In some embodiments of the present invention, some of the various substrate processing elements are located on opposite sides of the substrate 1000, which in the embodiment depicted in the figures would be the elements located at docks 300 and 302. In some embodiments, the elements may be removed and installed, and otherwise replaced, etc., while the substrate 1000 extends between the pertinent respective dock assemblies, as detailed above. That is, in this regard, during reconfiguration of the press, it is unnecessary in such embodiments to move or substantially move/change the substrate path. For example, the impression element may be removed and replaced while the other elements are in inking communication with the substrate Oust as some elements may be replaced while other elements are in inking communication with each other), and/or other elements may be removed/replaced while the impression element is in contact with the substrate.

In some embodiments of the present invention, it is the docking assembly to the right of the substrate that receives the impression surface. In some embodiments, other docking assemblies or all the docking assembly may be configured to receive an impression surface. Accordingly, in some embodiments of the present invention, the substrate path may be moved so as to interface with the substrate as appropriate.

In some embodiments of the present invention, the press is configured to alternatively drive and idle some or all of the various elements of a given processing station 200. In this regard, by way of example only and not by way of limitation, some presses are configured to selectively drive and idle the impression element when received in dock assembly 300. Some embodiments permit some or all of the elements in a given processing station to be alternatively driven or idled as individually desired by the operator. However, in other embodiments, some elements may be always idled while other elements may be always driven.

In some embodiments of the present invention, the dock assemblies of the printing stations are such that when the various processing elements are located in the dock assemblies, respective centers of rotation of the elements are substantially horizontally aligned. In some embodiments, this allows for reduced vibration and/or reduced deflection and/or the production of a simpler mechanism. Further, in some embodiments, movement of the processing surfaces permits the pressure applied to the substrate and/or the pressure applied to the various processing elements to be adjusted and/or controlled. Also, this may permit the size of a gap between the elements to be controlled.

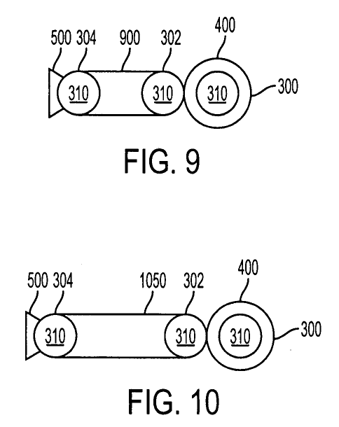

In another exemplary embodiment of a reconfigurable substrate processing press according to the present invention, an exchangeable, flexible gravure sleeve may be extended between two of the mandrels 310 located in respective dock assembles (e.g., 302 and 304) located on one side of the substrate 1000. This exchangeable, flexible gravure sleeve is in the form of an oblong endless belt 900, as may be seen in FIG. 9, or belt 1050, as may be seen in FIG. 10. In this embodiment, the gravure image is engraved on the surface of the oblong endless belt, which in some embodiments is a flexible steel band 900/1050. In some embodiments the present invention utilizing a press configured to receive an exchangeable flexible gravure sleeve in the form of an oblong endless belt, the oblong endless belt allows for a repeat length of a given processing job (i.e., gravure printing job) to be varied by utilizing different oblong endless belts that have different repeat lengths. (Compare FIG. 9 to FIG. 10, the latter depicting a belt with a longer repeat length.) In this regard, FIGS. 9 and 10 depict a side view of a portion of a station of a substrate processing press configured for gravure printing utilizing the flexible gravure sleeve in the form of an oblong endless belt. As may be seen, an impression element 400 is positioned at docking station 300 about a mandrel/cylinder 310. Adjacent to this is a flexible gravure sleeve in a form of a oblong endless belt 900/1050 that extends from docking assembly 302 to docking assembly 304. As may be seen, the belt wraps around mandrel 310 of docking station 302 and also mandrel 310 of docking assembly 304 in a manner that is analogous to the structure of a conveyor belt, were the mandrels serve as pulleys. A chambered doctor blade 500 is in inking communication with the gravure sleeve 900/1050 proximate the docking station 304.

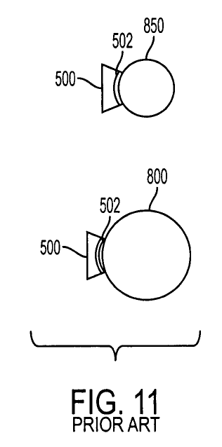

The flexible sleeve according to this embodiment has advantages over the prior art. For example, in the prior art, when the repeat length of a given gravure printing job needs to be changed, a new gravure cylinder of different diameter is installed on the station adjacent the impression element. This has the negative effect of requiring the sealing element 502 of the chambered doctor blade 500 to be adjusted and/or the entire chambered doctor blade to be exchanged for a new one having a different sealing element 502 to mate with the gravure element. This effect may be clearly seen with reference to FIG. 11, where the seal 502 of the chambered doctor blade 500 has a contact radius that is equivalent to the sleeve 850, but the radius is much smaller in comparison to the sleeve 800. Accordingly, in the prior art, the chambered doctor blade 500 and/or the seal 502 of the chambered doctor blade 500 must be adjusted to compensate for the different diameters of the gravure sleeve 800/850; diameters that change, to obtain a different repeat length.

Conversely, according to the present embodiment, to obtain a different repeat length, for example, a longer repeat length (compare FIG. 9 to FIG. 10, the latter having a longer repeat length) a gravure sleeve in a form of a flexible endless belt 1050 having a repeat length that is longer than the repeat length of the prior belt may be utilized on mandrels 310 having similar diameters for the two belts 900/1050. In this regard, comparing FIG. 9 to FIG. 10, it can be seen that the repeat length of the flexible gravure sleeve 1050 of FIG. 10 is longer than that of flexible gravure sleeve 900 depicted in FIG. 9. This extra repeat length is obtained even though the diameters of the elements contacting the diameters of the mandrel 310 in FIG. 9 and FIG. 10 are the same. Accordingly, it is not necessary to replace the chambered doctor blade 500 to obtain the different repeat lengths, to adjust an angle of blades in the chambered doctor blades 500 to obtain the different repeat lengths, and/or to adjust the seal 502 of the chambered doctor blade 500 to a contact radius to account for an element having a new radius, because a new contact radius is not present—the contact radius is the same. Accordingly, in embodiments that utilize the flexible gravure sleeve in the form of an oblong endless belt, the “working radius/diameter” of the gravure sleeve (i.e., the radius/diameter that interfaces with the chambered doctor blade) need not change to obtain different repeat lengths.

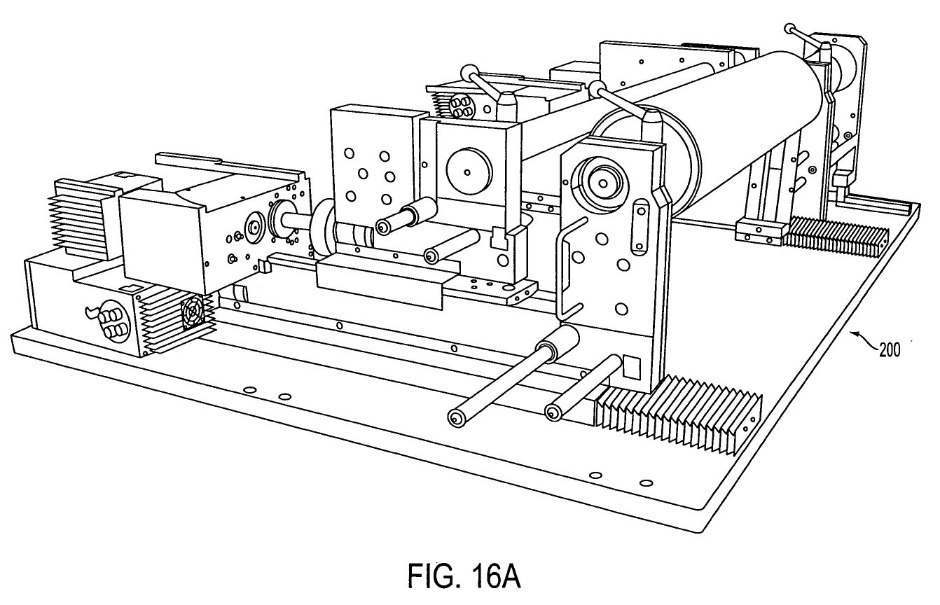

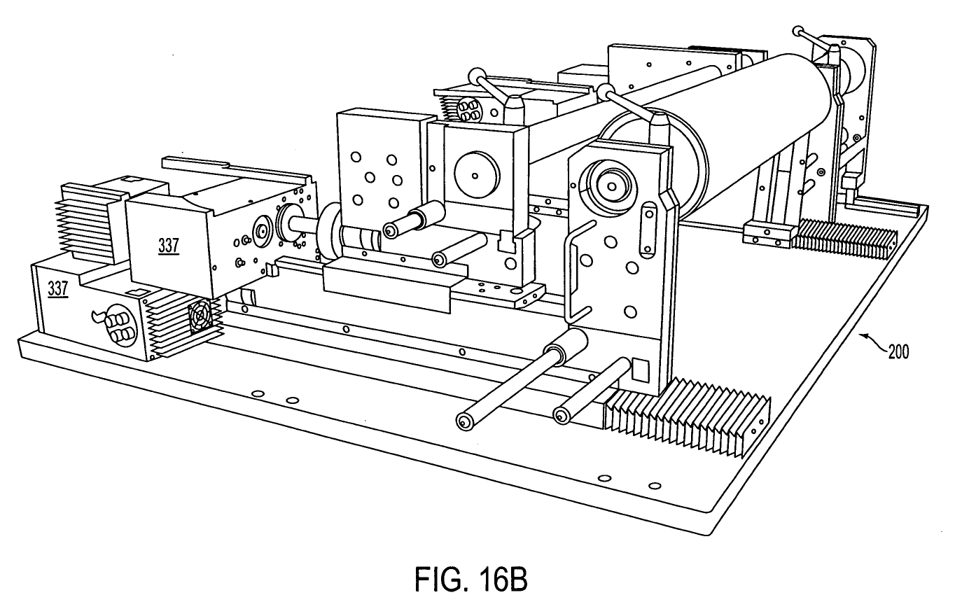

As may be extrapolated by comparing FIGS. 9 and 10, the press according to some embodiments is configured such that the mandrels 310 may be moved at least in the horizontal direction to account for the different repeat lengths of the various flexible gravure sleeves. It is noted that in other embodiments of the present invention, the mandrels are configured to move in the vertical direction as well, and/or other directions. It is also noted that the embodiments of the present invention that do not utilize the flexible gravure sleeve in the form of an oblong endless belt may also have mandrels that are movable in various directions. In some embodiments, the mandrels are easily removed to provide for clearance. In this regard, as detailed above, movable mandrels are useful in such scenarios when converting from offset gravure printing to direct gravure printing, etc. In some embodiments, the mandrels are on tracks or jack screws or precision actuators to permit movement. FIGS. 16a and 16b present an exemplary embodiment showing a support system for the mandrels, where the mandrels are supported on a rail system. As may be seen, in some embodiments, computer controlled servo-positioning motors 337 are utilized to adjust the location of the mandrels. In this regard, input to the computer that controls the positioning motors maybe the coordinates/desired clearances/pressure between the components, type of processing technologies utilized, the repeat length, etc. In some embodiments, the positions may be incrementally adjusted by the operator. In some embodiments, the information may be inputted manually by the operator. Manual lead/jack screws may be used as well to adjust the location of the elements. Other embodiments of the present invention may be configured with one or more mandrels/cylinders 310 that do not move—some embodiments may be configured such that the flexible sleeve may be looped over one mandrel to reach another mandrel. Any configuration that will permit a flexible sleeve to be utilized in gravure printing may be utilized with the present invention.

In regard to moving the mandrel(s), the mandrel(s) are movable such that in some embodiments the mandrel(s) will accurately/effectively tension the flexible gravure sleeve in the form of an elongated endless belt. Some embodiments of the present invention utilize transducers or the like to evaluate the locations of the mandrels and determine proper locations for proper tensioning. In some embodiments, there are sensors that sense the torque on a motor that moves the mandrels. In some embodiments, the separation distances of the mandrels that are used as pulleys for the flexible gravure sleeve are determined automatically by a computer system or the like or logic having a feed-back loop, and/or the press includes a control system to automatically move the mandrels so that the proper tension is obtained. In other embodiments, a manual system may be utilized where a press operator controls the adjustment of the distances.

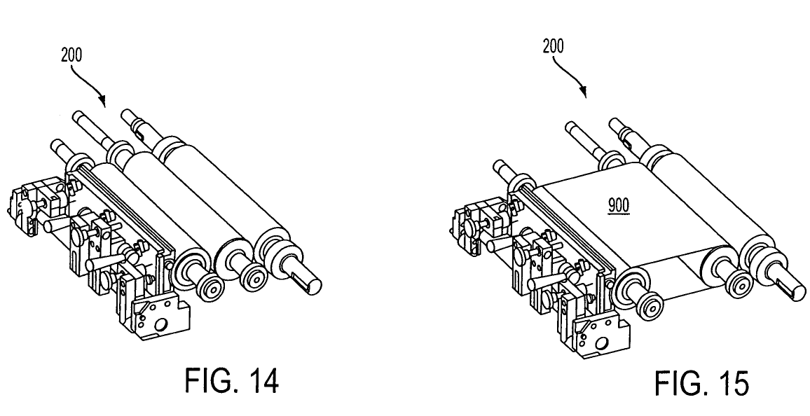

In embodiments utilizing the flexible gravure sleeve in the form of an elongated endless belt, as depicted by way of example and not by way of limitation in FIGS. 9 and 10, the press/station may be reconfigured in a manner similar to and/or the same as those detailed above with respect to changing from one print technology to another. In this regard, by way of example, in a processing press having a station configured for flexographic printing with three discrete separate flexographic printing elements (the impression element, the flexographic plate sleeve and the anilox sleeve); this station may be reconfigured for gravure printing utilizing the flexible sleeve in the form of an oblong endless belt. Still further in this regard, a standard gravure processing station which utilizes three rotating or two rotating gravure elements, including an impression element, may be reconfigured to utilize the oblong endless belt configuration as well. FIG. 14 presents a station configured for flexographic processing, while FIG. 15 presents that station reconfigured for gravure processing utilizing the flexible gravure sleeve 900.

The impression element utilized for gravure printing with the flexible elongated oblong belt according to some embodiments of the present invention will be compliant, as is the case with other impression elements utilized for gravure printing.

It is noted that in some embodiments of the present invention, the press includes a controller, which may be a simple processor, that is configured to recognize which processing technologies are being utilized in a given station. The controller may further be configured to control the press in an automatic function, and to automatically identify pacing factors and registration factors to obtain desired processing performance. The present invention includes methods to practicing the invention, software to practice the invention, logic (that is hardware and or software and or firmware, etc.), and apparatuses configured to implement the present invention. Accordingly, the present invention includes a program product and hardware and firmware for implementing algorithms to practice the present invention, as well as the systems and methods described herein, and also for the control of the devices and implementation of the methods described herein. It is noted that the term “processor,” as used herein, encompasses both simple circuits and complex circuits, as well as computer processors.

Given the disclosure of the present invention, one versed in the art would appreciate that there are other embodiments and modifications within the scope and spirit of the present invention. Accordingly, all modifications attainable by one versed in the art from the present disclosure within the scope and spirit of the present invention are to be included as further embodiments of the present invention.

What is claimed is:

1. A substrate processing press, comprising:
a first substrate processing station including:
a first dock assembly configured to readily receive, readily retain and readily release a first exchangeable substrate processing element while the first dock assembly is attached to the press; and
a second dock assembly adjacent to the first dock assembly configured to readily receive, readily retain and readily release a second exchangeable substrate processing element while the first exchangeable substrate processing element is retained in the first dock assembly and attached to the press and while the second dock assembly is attached to the press,
wherein the press is configured such that the first exchangeable substrate processing element and the second exchangeable substrate processing element are removable from the press while the other exchangeable substrate processing element remains in the press,
wherein the press is configured such that the first exchangeable substrate processing element, when docked in the first dock assembly, and the second exchangeable substrate processing element, when docked in the second dock assembly, simultaneously contact opposite sides of a substrate passing through the first substrate processing station at substantially the same longitudinal location of the substrate, and
wherein the second dock assembly is configured to readily receive, readily retain and readily release at separate temporal locations (i) the second exchangeable substrate processing element and (ii) a third exchangeable substrate processing element that is of a different processing technology than that of the second exchangeable substrate processing element while the second dock assembly is attached to the press and while the first exchangeable substrate processing element is attached to the press.

2. The press of claim 1, wherein at least a portion of one of the first and second dock assemblies is movable so as to permit an operator to adjust a contact pressure (i) between the first and second processing elements and/or (ii) on the substrate due to movement of the portion.

3. The press of claim 1, wherein the press is configured to readily receive, readily retain and readily release the first exchangeable substrate processing element when the substrate is extended between the first and the second dock assemblies while the first and second dock assemblies are attached to the press,
wherein the press is configured to readily receive, readily retain and readily release the second exchangeable substrate processing element when the substrate is extended between the first and the second dock assemblies while the first and second dock assemblies are attached to the press, and
wherein the press is configured such that the first exchangeable substrate processing element and the second exchangeable substrate processing element is removable from the press while the substrate is extended between the first and the second dock assemblies.

4. The press of claim 1, wherein the first exchangeable substrate processing element is an impression element, and wherein the press is configured to selectively drive and idle the impression element when received in the first dock assembly.

5. The press of claim 1, wherein the second exchangeable substrate processing element is an element selected from the group comprising at least a flexographic element and a gravure element, wherein the second dock assembly is configured to receive, at different temporal positions, the flexographic element and the gravure element while the second dock assembly is attached to the press so as to reconfigure the first station from a flexographic printing station to a gravure printing station, and wherein the press is configured to drive the second exchangeable substrate processing element.

6. The press of claim 1, wherein the second exchangeable substrate processing element is an element selected from the group comprising at least a flexographic plate, a lithographic offset blanket, a gravure imaged sleeve, a substrate cutter, a rotary screen and a gravure offset blanket, and wherein the second dock assembly is configured to receive, at different temporal locations, the flexographic plate, the lithographic offset blanket, the gravure imaged sleeve, the substrate cutter and the gravure offset blanket while the second dock assembly is attached to the press, and wherein the press is configured to drive the second exchangeable substrate processing element.

7. The press of claim 1, wherein the first dock assembly includes an impression cylinder configured to receive an impression element, and wherein the second dock assembly includes a driven mandrel configured to readily receive, readily retain and readily release, at different temporal locations, a flexographic element and a gravure element while the second dock assembly is attached to the press so as to reconfigure the first station from a flexographic printing station to a gravure printing station.

8. The press of claim 1, further comprising a third dock assembly adjacent to the second dock assembly configured to readily receive, readily retain and readily release a fourth exchangeable substrate processing element while the first exchangeable substrate processing element is operationally retained in the first dock assembly and in the press, while the second exchangeable substrate processing element is operationally retained in the second dock assembly and in the press and while the third dock assembly is attached to the press,
wherein the press is configured such that the fourth exchangeable substrate processing element is removable from the press while the first and second exchangeable substrate processing elements remain connected to the press, and
wherein the press is configured such that the second exchangeable substrate processing element, when docked in the second dock assembly, and the fourth exchangeable substrate processing element, when docked in the third dock assembly, contact each other.

9. The press of claim 8, wherein the fourth exchangeable substrate processing element is an element selected from the group comprising at least an anilox element and a gravure element, and wherein the third dock assembly is configured to receive, at different temporal positions, the anilox element and the gravure element while the third dock assembly is attached to the press, and wherein the press is configured to drive the third exchangeable substrate processing element.

10. The press of claim 8, wherein the fourth exchangeable substrate processing element is an element selected from the group comprising at least an anilox sleeve, a lithographic offset plate and a gravure imaged sleeve, and wherein the third dock assembly is configured to receive, at different temporal positions, the anilox sleeve, the lithographic offset plate and the gravure imaged sleeve while the third dock assembly is attached to the press.

11. The press of claim 8, wherein at least one of:
(i) the third dock assembly is configured to readily receive, readily operationally retain and readily release a print process inker while the first exchangeable substrate processing element is operationally retained in the first dock assembly and attached to the press and the third dock assembly is attached to the press; and
(ii) the press includes a fourth dock assembly is configured to readily receive, readily operationally retain and readily release the print process inker while the first exchangeable substrate processing element is operationally retained in the first dock assembly and attached to the press and the fourth dock assembly is attached to the press,
wherein the press is configured such that the print process inker is removable from the press while the first and second exchangeable substrate processing elements remain in the press, and
wherein the press is configured such that the second exchangeable substrate processing element, when docked in the second dock assembly, and the print process inker, when docked in the third dock assembly, are in inking communication with each other.

12. The press of claim 8, further comprising a fourth dock configured to readily receive, readily operationally retain and readily release a print process inker while the first exchangeable substrate processing element is retained in the first dock assembly and attached to the press and the second, third and fourth dock assemblies are attached to the press,
wherein the press is configured such that the print process inker is removable from the press while the first, second and third exchangeable substrate processing elements remain connected to the press, and
wherein the press is configured such that at least one of (i) the third exchangeable substrate processing element, when docked in the third dock assembly, and (ii) the second exchangeable substrate processing element, when docked in the second dock assembly, and the print process inker, when docked in the fourth dock assembly, are in inking communication with each other.

13. The press of claim 12, wherein the print process inker is selected from the group comprising an open pan, a chambered doctor blade, a variable geometry chambered doctor blade and an offset inker, and wherein the fourth dock assembly is configured to receive, at different temporal locations, the chambered doctor blade, the variable geometry chambered doctor blade and the offset inker while the fourth dock assembly is attached to the press.

14. The press of claim 1, wherein the press is configured such that during operational retention of the first and second substrate processing elements in the press, respective centers of rotation of the first and second substrate processing elements are substantially horizontal aligned.

15. A substrate processing press, comprising:
a first substrate processing station including:
a first driven mandrel attached to the press configured to readily receive, readily retain, readily release and readily drive a first exchangeable substrate processing element;
a second driven mandrel attached to the press adjacent to the first mandrel configured to readily receive, readily retain, readily release and readily drive a second exchangeable substrate processing element while the first exchangeable substrate processing element is retained in the first dock assembly and attached to the press, and
an impression cylinder attached to the press adjacent to the first mandrel configured to readily receive, readily retain, readily release and readily drive an impression element,
wherein the press is configured such that the first exchangeable substrate processing element, the second exchangeable substrate processing element and the impression element are removable from the press while the other elements remain in the press,
wherein the press is configured such that the first exchangeable substrate processing element, when received on the first mandrel, and the impression element, when received on the impression cylinder, simultaneously contact opposite sides of a substrate passing through the first substrate processing station at substantially the same longitudinal location of the substrate,
wherein the press is configured such that the first exchangeable substrate processing element, when retained on the first mandrel, and the second exchangeable substrate processing element, when retained on the second mandrel, contact each other, and
wherein the first mandrel is configured to readily receive, readily retain and readily release at separate temporal locations (i) the first exchangeable substrate processing element and (ii) a third exchangeable substrate processing element that is of a different processing technology than that of the first exchangeable substrate processing element while the second mandrel is attached to the press and the impression cylinder is attached to the press.

16. The press of claim 15, wherein the press is configured to selectively drive and idle the impression element.

17. A substrate processing press, comprising:
a first substrate processing station including:
a first exchangeable substrate processing element attached to the press; and
a second exchangeable substrate processing element attached to the press,
wherein the press is configured to readily receive, readily retain and readily release the first exchangeable substrate processing element when a substrate is extended between the first and the second exchangeable elements while the second exchangeable substrate processing element is attached to the press,
wherein the press is configured to readily receive, readily operationally retain and readily release the second exchangeable substrate processing element when the substrate is extended between the first and the second dock exchangeable elements while the first exchangeable substrate processing element is attached to the press,
wherein the press is configured such that the first exchangeable substrate processing element and the second exchangeable substrate processing element simultaneously contact opposite sides of a substrate passing through the first substrate processing station at substantially the same longitudinal location of the substrate, and
wherein the press is configured such that the first exchangeable substrate processing element and the second exchangeable substrate processing element is removable from the press while the substrate is extended between the first and the second exchangeable substrate processing elements.

18. A substrate processing press, comprising:
a first substrate processing station including:
a first mandrel attached to the press configured to readily receive, readily retain, and readily release an exchangeable gravure offset blanket;
a second mandrel attached to the press adjacent to the first mandrel configured to readily receive, readily retain, and readily release an exchangeable gravure sleeve; and
an impression cylinder attached to the press adjacent to the first mandrel, the impression cylinder configured to readily receive, readily retain and readily release an impression element,
wherein the press is configured such that the exchangeable gravure offset blanket may be exchanged with a first separate exchangeable substrate processing element while the substrate is extended between the impression cylinder and the first mandrel,
wherein the press is configured such that the gravure sleeve may be exchanged with a second separate exchangeable substrate processing element while the substrate is extended between the impression cylinder station and the first mandrel,
wherein the press is configured such that the gravure offset blanket, when received on the first mandrel, and the impression element, when received on the impression cylinder, simultaneously contact opposite sides of the substrate passing through the press at substantially the same longitudinal location of the substrate, and
wherein the press is configured such that the gravure sleeve, when retained on the second mandrel, and the gravure offset blanket, when retained on the first mandrel, contact each other.

19. The press of claim 18, wherein the first exchangeable substrate processing element includes elements selected from the group including at least a flexo plate sleeve, an offset blanket, a gravure imaged sleeve, and a substrate cutter, and wherein the second exchangeable substrate processing element includes elements selected from the group including at least an offset plate and an anilox sleeve.

20. The press of claim 18, wherein the first exchangeable substrate processing element includes a gravure sleeve, and wherein press is configured to receive a variable geometry chambered doctor blade.

21. The press of claim 18, wherein at least one of the mandrels is a driven mandrel.

22. The press of claim 18, wherein the press is configured such that geometric centers of the first and second mandrels and the impression cylinder are substantially horizontal aligned.

23. The press of claim 1, wherein the first exchangeable substrate processing element has a face area that is about the same as the second exchangeable substrate processing element.

24. The press of claim 1, wherein the press is configured to receive a rotary screen printing assembly that cooperates with the first exchangeable substrate processing element.

25. The press of claim 15, wherein the driven mandrels and impression cylinder are selectively driven.

26. A gravure printing press, comprising:
a first mandrel and a second mandrel attached to the press configured to readily receive, readily retain, and readily release an exchangeable gravure element;
a chambered doctor blade; and
a first exchangeable flexible gravure belt extending around the first and second mandrel in the form of an oblong endless belt.

27. The press of claim 26, wherein the distance from a center of the first mandrel and a center of the second mandrel is adjustable in order to maintain an effectively similar operational tension, with respect the first exchangeable flexible gravure belt, on a second exchangeable flexible gravure belt of substantially longer repeat length than the first exchangeable flexible gravure belt when the first exchangeable flexible belt is replaced by the second exchangeable gravure belt and gravure printing is executed with the press.

28. The press of claim 26, wherein the press is configured to permit a repeat length to be substantially changed and gravure printing to be executed without the need to (i) replace the chambered doctor blade, (ii) adjust an angle of blades in the chambered doctor blade, and (iii) adjust a seal of the chambered doctor blade from a contact radius of the first exchangeable flexible gravure belt.

29. A gravure printing press, comprising:
a chambered doctor blade; and
a first exchangeable flexible oblong gravure belt in the form of an oblong endless belt,
wherein the gravure printing press is configured such that a repeat length may be substantially changed and gravure printing may be executed without the need to (i) replace the chambered doctor blade, (ii) adjust an angle of blades in the chambered doctor blade, and (iii) adjust a seal of the chambered doctor blade to a contact radius of the first exchangeable flexible gravure belt.

30. The press of claim 26, wherein the mandrels are pulleys.

31. The press of claim 1, wherein the second exchangeable substrate processing element is a flexible gravure belt in the form of an oblong endless belt.

32. The press of claim 8, including a flexible gravure belt in the form of an oblong endless belt, wherein the flexible gravure belt in the form of an oblong endless belt travels between the second dock assembly and the third dock assembly.

33. The press of claim 32, further comprising a first chambered doctor blade, wherein the press is configured to utilize the first doctor blade for flexo printing and for gravure printing without the need to (i) replace the first chambered doctor blade, (ii) adjust an angle of blades in the chambered doctor blade, and (iii) adjust a seal of the chambered doctor blade to a contact radius of the first exchangeable flexible gravure belt.

34. A method of reconfiguring a substrate processing press, comprising:
obtaining a substrate processing press including a first exchangeable substrate processing element operationally retained and a second exchangeable substrate processing element operationally retained in the press, wherein the first exchangeable substrate processing element and the second exchangeable substrate processing element simultaneously contact opposite sides of a substrate passing between the first and second exchangeable substrate processing elements at substantially the same longitudinal location of the substrate; and
at least one of:
removing the second exchangeable substrate processing element from the press while the first substrate processing element is retained in the press and the substrate passes between the first and second exchangeable substrate processing elements; and
removing the first exchangeable substrate processing element from the press while the second substrate processing element is retained in the press and the substrate passes between the first and second exchangeable substrate processing elements.

35. The method of claim 34, further comprising at least one of the actions of:
replacing the second exchangeable substrate processing element with a third exchangeable substrate processing element that is of a different processing technology than that of the second exchangeable substrate processing element while the first exchangeable substrate processing element is attached to the press or a fourth exchangeable substrate processing element that has replaced the first exchangeable substrate processing element and is of a different processing technology than the first exchangeable substrate processing element is attached to the press, wherein immediately upon completion of this action, the substrate runs between the first and third elements or the fourth and third elements; and
replacing the first exchangeable substrate processing element with the fourth exchangeable substrate processing element at the previous location of the first exchangeable substrate processing element that is of a different processing technology than that of the first exchangeable substrate processing element while the second exchangeable substrate processing element is attached to the press or the third exchangeable substrate processing element is attached to the press, wherein immediately upon completion of this action, the substrate runs between the second and fourth elements or the third and fourth elements.

36. The method of claim 34, further comprising at least one of the actions of:
replacing the second exchangeable substrate processing element with a third exchangeable substrate processing element that is of a different processing technology than that of the second exchangeable substrate processing element while the first exchangeable substrate processing element is attached to the press or a fourth exchangeable substrate processing element that has replaced the first exchangeable substrate processing element is attached to the press at substantially the exact same location where the first element was located and is of a different print technology than that of the first element, wherein the third substrate processing element is placed on the press at substantially the exact same location where the second substrate processing element was located prior to removal from the press; and
replacing the first exchangeable substrate processing element with the fourth exchangeable substrate processing element that is of a different processing technology than that of the first exchangeable substrate processing element while the second exchangeable substrate processing element is attached to the press or the third exchangeable substrate processing element that has replaced the second exchangeable substrate processing element is attached to the press at substantially the exact same location where the second element was located, wherein the fourth substrate processing element is placed on the press at substantially the exact same location where the first substrate processing element was located prior to removal from the press.

37. The method of claim 34, wherein the second and third exchangeable substrate processing elements are elements selected from the group comprising at least a flexographic element and a gravure element.

38. The method of claim 34, wherein the second and third exchangeable substrate processing elements are element selected from the group comprising at least a gravure offset blanket, a lithographic offset blanket, a gravure imaged sleeve, a substrate cutter and a flexographic plate.

39. The method of claim 34, wherein the first and fourth exchangeable substrate processing elements are elements selected from the group comprising at least a hard impression surface for flexographic substrate processing and a compliant impression surface for gravure substrate processing.

40. The method of claim 36, wherein the obtained press further includes a fifth exchangeable substrate processing element adjacent to the second substrate processing element at a substantially opposite side of the second substrate processing element with respect to the first substrate processing element, the process further comprising at least one of the actions of:
replacing the fifth exchangeable substrate processing element with a sixth exchangeable substrate processing element that is of a different processing technology than that of the fifth exchangeable substrate processing element while the first exchangeable substrate processing element is attached to the press or the fourth exchangeable substrate processing element that has replaced the first exchangeable substrate processing element is attached to the press at substantially the exact same location where the first element was located and is of a different print technology than that of the first element, wherein the sixth substrate processing element is placed on the press at substantially the exact same location where the fifth substrate processing element was located prior to removal from the press; and
replacing the fifth exchangeable substrate processing element with the sixth exchangeable substrate processing element that is of a different processing technology than that of the fifth exchangeable substrate processing element while the second exchangeable substrate processing element is attached to the press or a third exchangeable substrate processing element that has replaced the second exchangeable substrate processing element is attached to the press at substantially the exact same location where the second element was located and is of a different print technology than that of the second element, wherein the sixth substrate processing element is placed on the press at substantially the exact same location where the fifth substrate processing element was located prior to removal from the press.

41. The process of claim 40, wherein the second and third exchangeable substrate processing elements are element selected from the group comprising at least a gravure offset blanket, a lithographic offset blanket, a gravure imaged sleeve, a substrate cutter and a flexographic plate, and wherein the fifth and sixth exchangeable substrate processing element is an element selected from the group comprising at least an anilox element, a lithographic offset plate and a gravure imaged sleeve.

42. A substrate processing press, comprising:
a first substrate processing station including:
a first dock means for readily receiving, readily retaining and readily releasing a first exchangeable substrate processing element while the first dock means is attached to the press; and
a second dock means adjacent to the first dock means for readily receiving, readily retaining and readily releasing a second exchangeable substrate processing element while the first exchangeable substrate processing element is retained in the first dock means and attached to the press and while the second dock means is attached to the press,
wherein the press is configured such that the first exchangeable substrate processing element and the second exchangeable substrate processing element are removable from the press while the other exchangeable substrate processing element remains in the press, and
wherein the press is configured such that the first exchangeable substrate processing element, when docked in the first dock means, and the second exchangeable substrate processing element, when docked in the second dock means, simultaneously contact opposite sides of a substrate passing through the first substrate processing station at substantially the same longitudinal location of the substrate.

43. The press of claim 1, wherein:
the second dock assembly includes a mandrel and is configured to readily receive, readily retain and readily release at separate temporal locations (i) the second exchangeable substrate processing element and (ii) a third exchangeable substrate processing element that is of a different processing technology than that of the second exchangeable substrate processing element while the second dock assembly is attached to the press and while the first exchangeable substrate processing element is attached to the press;
the mandrel includes orifices arrayed on its surface, the orifices being in fluid communication with a source of pressurized air;
the press is configured to permit an operator to regulate the flow of pressurized air through the orifices such that sufficient amounts of pressurized air may be permitted to flow through the orifices so that the mandrel may readily receive the second exchangeable substrate processing element by expanding an interior diameter of the second exchangeable substrate processing element thorough application of the pressurized air through the orifices against the interior diameter of the second exchangeable substrate processing element so that the second exchangeable substrate processing element fits at least slidably around the mandrel;
the press is configured to permit the operator to regulate the flow of pressurized air through the orifices such that the flow of pressurized air is decreased, after the second exchangeable substrate processing element is received on the mandrel, such that the expanded interior diameter of the second exchangeable substrate processing element contracts to be snug around the mandrel so as to permit the mandrel to readily retain the second exchangeable substrate processing element on the mandrel; and
the press is configured to permit the operator to regulate the flow of pressurized air through the orifices such that sufficient amounts of pressurized air may be permitted to flow through the orifices so that the mandrel may readily release the second exchangeable substrate processing element by expanding an interior diameter of the second exchangeable substrate processing element thorough application of the pressurized air through the orifices against the interior diameter of the second exchangeable substrate processing element so that the second exchangeable substrate processing element fits slidably around the mandrel.

44. The method of claim 34, wherein the action of removing the second exchangeable substrate processing element from the press includes the action of:
regulating a flow of pressurized air through orifices in a mandrel on which the second exchangeable substrate processing element is located such that sufficient amounts of pressurized air is permitted to flow through the orifices so that an interior diameter of the second exchangeable substrate processing element is expanded by the application of the pressurized air through the orifices against the interior diameter of the second exchangeable substrate processing element so that the second exchangeable substrate processing element fits at least slidably around the mandrel; and
regulating a flow of pressurized air through orifices in a mandrel on which the first exchangeable substrate processing element is located such that sufficient amounts of pressurized air is permitted to flow through the orifices so that an interior diameter of the first exchangeable substrate processing element is expanded by the application of the pressurized air through the orifices against the interior diameter of the first exchangeable substrate processing element so that the first exchangeable substrate processing element fits at least slidably around the mandrel.

45. The press of claim 32, further comprising a first chambered doctor blade, wherein the press is configured to utilize the first doctor blade for gravure printing with, at two temporally different locations, two different gravure belts of substantially different repeat lengths without the need to (i) replace the first chambered doctor blade, (ii) adjust an angle of blades in the chambered doctor blade, and (iii) adjust a seal of the chambered doctor blade to a contact radius of the first exchangeable flexible gravure belt.
